(19) United States
(12) Patent Application Publication
(10) Pub. No.: US 2026/0200439 A1
(43) Pub. Date: Jul. 16, 2026

(54) SERVICE MACHINE FOR APPLYING CHEMICAL TO A VEHICLE COMPONENT

(71) Applicant: Honda Motor Co., Ltd., Tokyo (JP)

(72) Inventor: Benjamin L. Linfield, Dublin, OH (US)

(21) Appl. No.: 19/019,114

(22) Filed: Jan. 13, 2025

(51) Int. Cl. B60S 3/04; B08B 3/02; B08B 3/08

(52) U.S. Cl. CPC B60S 3/044; B08B 3/026; B08B 3/08

(57) ABSTRACT

A service machine includes a housing and a valve assembly mounted to the housing and configured to receive at least one cleaning fluid from at least one cleaning fluid source and a chemical from a chemical reservoir. The service machine also includes a nozzle fluidly connected to the valve assembly and configured to spray the at least one cleaning fluid and the chemical to the one or more components of the vehicle. The valve assembly selectively controls the flow of the at least one cleaning fluid and the chemical to the nozzle. The service machine is used to apply a chemical to one or more component of a vehicle.

### BACKGROUND

The disclosed subject matter relates generally to a service machine. More particularly, the disclosed subject matter relates to a service machine suitable to apply a chemical to one or more components of a vehicle.

Currently, a wand or spray nozzle is operated by a user to apply wax on inside underbody frame members of a vehicle, and therefore lacks consistency and effectiveness.

### SUMMARY

In accordance with one embodiment of the present disclosure, a service machine is provided. The service machine is used to apply a chemical to one or more component of a vehicle. The service machine includes a housing and a valve assembly mounted to the housing and configured to receive at least one cleaning fluid from at least one cleaning fluid source and a chemical from a chemical reservoir. The service machine also includes a nozzle fluidly connected to the valve assembly and configured to spray the at least one cleaning fluid and the chemical to the one or more components of the vehicle. The valve assembly selectively controls the flow of the at least one cleaning fluid and the chemical to the nozzle.

In accordance with another embodiment of the present disclosure, a service machine is provided. The service machine is used for applying a chemical to one or more component of a vehicle. The service machine includes a housing and a valve assembly mounted to the housing and configured to receive at least one cleaning fluid from at least one cleaning fluid source and a chemical from a chemical reservoir. The service machine also includes a nozzle fluidly connected to the valve assembly and configured to spray the at least one cleaning fluid and the chemical to the one or more component of the vehicle. The valve assembly selectively controls the flow of the at least one cleaning fluid and the chemical to the nozzle. The service machine further includes a controller configured to control the valve assembly to deliver the at least one cleaning fluid and the chemical to the nozzle in a predefined sequence and control the amount of the at least one cleaning fluid and the chemical delivered to the nozzle

In accordance with yet a further embodiment of the present disclosure a service machine is provided. The service machine is used for applying a chemical to one or more component of a vehicle. The service machine includes a housing and a valve assembly mounted to the housing and configured to receive a compressed air from a pressurized air source, water from a water source, and a chemical from a chemical reservoir. The service machine also includes a nozzle fluidly connected to the valve assembly and configured to spray the compressed air, the water and the chemical to the one or more component of the vehicle. The valve assembly selectively controls the flow of the compressed air, the water and the chemical to the nozzle. Further, the service machine includes a controller configured to control the valve assembly to spray the compressed air, the water and the chemical from the nozzle in a predefined sequence and control the amount of compressed air, the water, and the chemical delivered to the nozzle. The predefined sequence includes delivering the compressed air from the nozzle, delivering the water to the nozzle upon delivering the compressed air to the nozzle, delivering the compressed air to the nozzle after delivering the water to the nozzle, and delivering the chemical to the nozzle after delivering the compressed air to the nozzle.

### BRIEF DESCRIPTION OF THE DRAWINGS

Certain embodiments of the present disclosure will be better understood from the following description taken in conjunction with the accompanying drawings in which:

FIG. 1 is a perspective view of a service machine, in accordance with one embodiment of the present disclosure;

FIG. 2 illustrates a schematic circuit diagram of the service machine, in accordance with one embodiment of the present disclosure;

FIG. 3 illustrates a perspective view of a nozzle of the service machine, in accordance with an embodiment of the present disclosure;

FIG. 4 is a zoom view of a portion of an underside frame of a vehicle, in accordance with one embodiment of the present disclosure; and

FIG. 5 is a zoom view of the underside frame of the vehicle with a nozzle of the service machine attached to the underside frame and an outlet portion of the nozzle extending inside a hole to apply chemical on an upper surface of the underside frame of the vehicle, in accordance with one embodiment of the present disclosure.

### DETAILED DESCRIPTION OF EXEMPLARY EMBODIMENTS

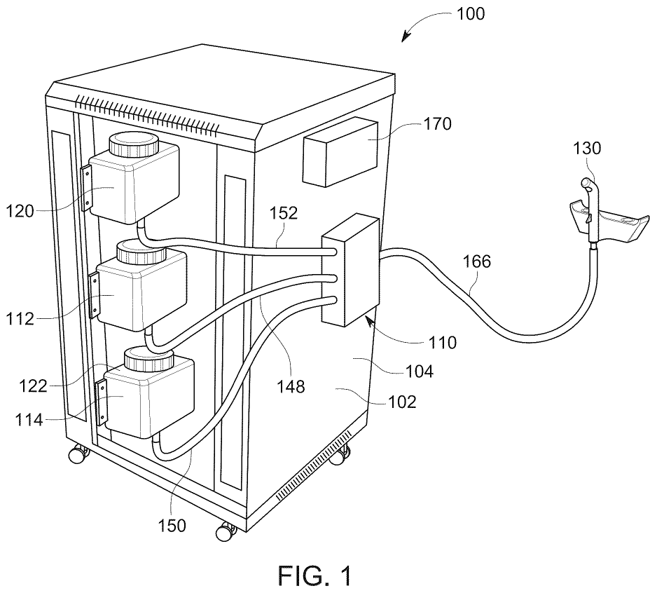

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-5, wherein like numbers indicate the same or corresponding elements throughout the views.

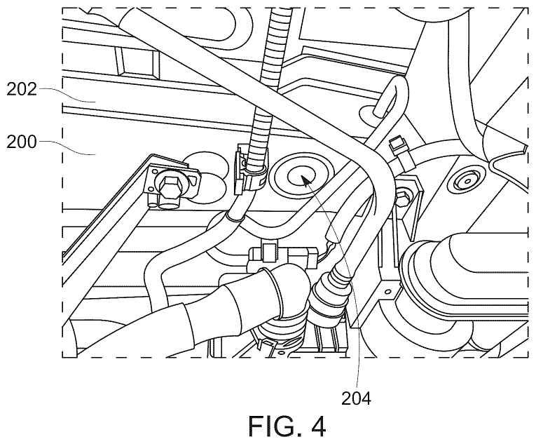

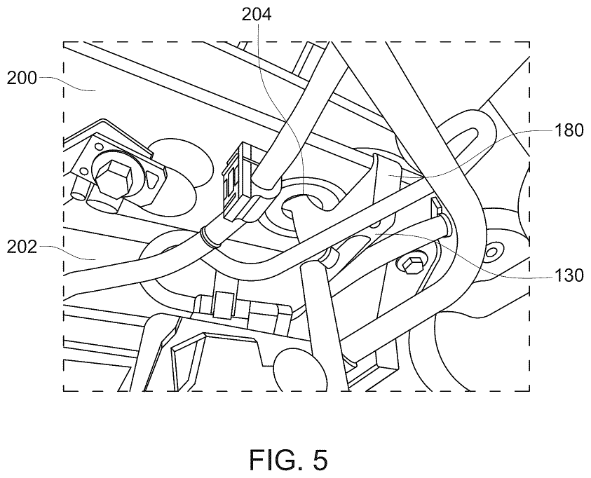

FIG. 1 illustrates a service machine, indicated generally at 100, to apply a chemical, for example, wax, on or treat one more or components of a vehicle 200, for example, an underside frame 202, shown in FIGS. 4 and 5, of the vehicle 200. As shown, the machine 100 includes a housing/frame 102, for example, a trolley 104, to hold one or more components of the machine 100. Trolley 104 facilitates the movement/transport of the machine 100 from one location to another location to carry out the chemical treatment of one or more components of the vehicle 200. Although the movable trolley 104 is shown and contemplated as the frame or the housing 102, it may be appreciated that the frame or the housing 102 may be stationary and facilitates the mounting of one or more components of the machine 100.

The machine 100 includes a valve assembly 110 mounted to the housing 102 and fluidly coupled to at least one cleaning fluid source, for example, a water source 112, and a compressed air source 114, and a chemical reservoir 120 that stores the chemical. Although two cleaning fluids, water and pressurized air, are contemplated for cleaning the component, it may be appreciated that only one cleaning fluid i.e., water or the compressed air, may be utilized for cleaning.

In the embodiment, the chemical reservoir 120 may be a bottle or a reservoir mounted to the housing 102. Also, the water source 112 is shown as a tank mounted to the housing 102, however, in some embodiments, the water source 112 may be a reservoir disposed separately from the housing 102 or a tap. Further, the air source 114 may be a compressor that compresses the atmospheric air or an accumulator 122, shown in FIG. 1, that stores the pressurized air, and is configured to deliver the air at a desired pressure. In some embodiments, a pressure regulator may be arranged between the valve assembly 110 and the air source 114 to control the pressure of air being delivered to the valve assembly 110. Although the air source 114 is shown to be mounted to the housing 102, it may be envisioned that the air source 114 may be arranged separately to the housing, and conduit facilitates a flow of compressed air from the air source 114 to the valve assembly 110.

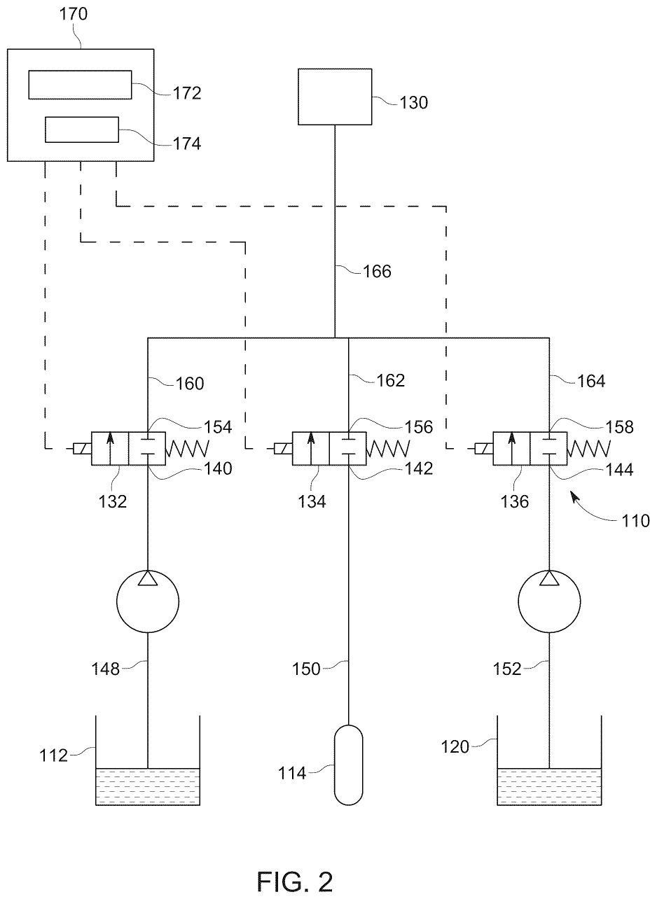

The valve assembly 110 controls the flow of fluids, i.e., water, pressurized air, and the chemical, from the associated fluid source, i.e., the water source 112, the air source 114, and the chemical reservoir 120, to a nozzle 130 that sprays the fluid on the vehicle component. In the illustrated embodiment, shown in FIG. 2, the valve assembly 110 includes at least one valve, for example, a first valve 132, a second valve 134, and a third valve 136, to control the flow of the water, the pressurized air, and the chemical, respectively, from the water source 112, the air source 114, and the chemical reservoir 120 to the nozzle 130. As shown, the valves are solenoid actuated ON-OFF valves. However, the one or more of the valves 132, 134, 136 may be metering valves to control rate of fluid delivery to the nozzle 130. In some embodiments, the valves 132, 134, 136 may be pneumatically, hydraulically, mechanically, magnetically, actuated valves. As the valves 132, 134, 136 are ON-OFF valves, each of the valve is adapted to be independently moved between an open position and a closed position. In the open position, each of the valves allow flow of a fluid from the associated fluid source to the nozzle, while in the closed position, the valves prevent the flow of the fluid from the associated fluid source to the nozzle 130.

To facilitate the receipt of the at least one cleaning fluid and the chemical, the valve assembly 110 includes at least one inlet port, for example, a first inlet port 140 and a second inlet port 142 fluidly connected to the water source 112, and the air source 114, and an inlet opening 144 fluidly connected to the chemical reservoir 120. As shown in FIG. 2, the first inlet port 140 is connected to the water source 112 via a first inlet conduit 148, the second inlet port 142 is connected to the air source 114 via a second inlet conduit 150, and the first inlet opening 144 is connected to the chemical reservoir 120 via a third inlet conduit 152.

Moreover, in the illustrated embodiment, the valve assembly 110 includes three outlet openings, for example, a first outlet opening 154 of the first valve 132, a second outlet opening 156 of the second valve 134 and a third outlet opening 158 of the third valve 136. The outlet openings 154, 156, 158 are fluidly connected to the nozzle 130. In the illustrated embodiment, the first outlet opening 154 is fluidly connected to the nozzle 130 via a first outlet conduit 160, while the second and third outlet openings 156, 158 are arranged fluidly connected to the nozzle 130 via second and third outlet conduits 162, 164. As shown, the outlet conduits 160, 162, 164 extend from respective outlet openings 154, 156, 158 to a main outlet conduit 166 which is connected to the nozzle 130. Accordingly, water, pressurized air, and the chemical flows from the respective valve 132, 134, 136 to the main outlet conduit 166 via the associated outlet conduits 160, 162, 164, and then to the nozzle 130.

Although, the valve assembly 110 having three separate valves 132, 134, 136 are shown and contemplated, it may be envisioned that the valve assembly 110 may include a single valve having two inlet ports 140, 142 connected to the water source 112, the compressed air source 114, one inlet opening 144 connected to the chemical reservoir 120, and a single outlet opening which is connected to the nozzle 130 via a single outlet conduit. Accordingly, the single valve includes suitable mechanism, known in the art, the fluidly can selectively connect and disconnect the first inlet port 140, the second inlet port 142, and the inlet opening 144 to the single outlet opening. It may be appreciated that valve is configured such that when the outlet opening is connected to any one of the inlet ports 140, 142 and the inlet opening 144, the outlet opening remains disconnected from other of inlet ports 140, 142 and the inlet opening 144. For example, when the outlet opening is connected to the first inlet port 140, the second inlet port 142 and the inlet opening 144 remains disconnected from the outlet opening, to allow the flow of the water to the nozzle 130, while preventing flow of the pressurized air and the chemical to the nozzle 130. Similarly, when the outlet opening is connected to the second inlet port 142, the first inlet port 140 and the inlet opening 144 remain disconnected from the outlet opening, allowing the pressurized air to flow to the nozzle 130, while preventing the flow of water and the chemical to the nozzle 130. Also, when the outlet opening is connected to the inlet opening 144, the first and second inlet ports 140, 142 remain disconnected from the outlet opening, allowing the chemical to flow to the nozzle 130, while preventing the flow of water and the pressurized air to the nozzle 130. It may be noted that the valve assembly 110 may include two valves instead of a single valve or three valves. In such a case, one of the valves that may be used to provide cleaning fluids to the nozzle 130 and includes the first and second inlet ports 140, 142 and a single outlet opening and is configured to connect either the first inlet port 140 to the outlet opening or the second inlet port 142 to the outlet opening to provide the cleaning fluids to the nozzle 130. Other of the valves may be similar to the third valve 136 that control the flow of the chemical from the chemical reservoir 120 to the nozzle 130.

To enable the control of the valve assembly 110 and to provide the cleaning fluids and the chemical fluid to the nozzle 130 as desired, for example, in a predefined sequence, the machine 100 may include a controller 170 communicatively coupled to the valve assembly 110, in the illustrated embodiment, to the first valve 132, the second valve 134, and the third valve 136, to move the valves 132, 134, 136 between the open position and the closed position. The first valve 132, in the open position, allows flow of water from the water source 112 to the nozzle 130, thereby connecting the first inlet port 140 to the first outlet opening 154, while, in the closed position, the flow of the water to the nozzle 130 from the water source 112 is prevented, thereby the first inlet port 140 is disconnected from the first outlet opening 154. Similarly, the second valve 134, in the open position, allows pressurized air to flow from the air source 114 to the nozzle 130, connecting the second inlet port 142 to the second outlet opening 156 while, in the closed position, the flow of the air to the nozzle 130 from the air source 114 is prevented by disconnecting the second inlet port 142 from the second outlet opening 156. Moreover, the third valve 136, in the open position, allows chemical to flow from the chemical reservoir 120 to the nozzle 130 by connecting the inlet opening 144 with the third outlet opening 158, while, in the closed position, the third valve 136 prevents flow of the chemical to the nozzle 130 by disconnecting the inlet opening 144 from the third outlet opening 158. The controller 170 is also configured to control the amount of the chemical and amount of the at least one cleaning fluid by controlling the opening and closing of the valves 132, 134, 136. In some embodiments, the controller 170 may control the pumps that pump the chemical from the chemical reservoir 120 and the water from the water source 112 to control the amount of the chemical and the water provided to the nozzle 130.

As shown in FIG. 2, the controller 170 includes a processor 172 and a memory 174 to respectively process and store the data to control one or more component of the machine to enable the chemical treatment of a component. The memory 174 may be integrated into the controller 170, but those skilled in the art will understand that the memory 174 may be separate from the controller 170 but onboard the machine 100, and/or remote from the controller 170, while still being associated with and accessible by the controller 170 to store information in and retrieve information from the memory 174 as necessary during the operation of the machine 100. Although the processor 172 is contemplated, it is also possible and contemplated to use other electronic components such as a microcontroller, an application specific integrated circuit (ASIC) chip, or any other integrated circuit device.

The controller 170 is configured to control the opening and closing of the valves 132, 134, 136 based on a predefined sequence stored inside the memory 174 of the controller 170. The controller 170 is configured to operate/actuate/control the valves 132, 134, 136 as per the predefined sequence upon actuation of a start switch (not shown) by an operator. The actuation of the start switch indicates the user desire to initiate the chemical treatment of the one or more components of the vehicle 200, for example, the underside frame 202, of the vehicle 200. Upon determination of the actuation of the start switch, the controller 170 operates the valves 132, 134, 136 as per the predefined sequence to clean the component with the at least one cleaning fluid, i.e., a first cleaning fluid and/or a second cleaning fluid, and then apply the chemical on the component.

In an embodiment, the predefined sequence includes delivering, at first, the first cleaning fluid i.e., compressed air, to the nozzle 130 to spray the first cleaning fluid on the component to clean the component. For so doing, the controller 170 may control the second valve 134 and move the second valve 134 to the open position to deliver the compressed air i.e., first cleaning fluid to the nozzle 130 and to spray the first cleaning fluid on the component via the nozzle 130, while keeping the first and third valves 132, 136 at the closed position. The controller 170 may keep the second valve 134 at the open position for a predetermined time to spray the compressed air on the component to effectively remove dirt and debris from the component.

The predefined sequence also includes delivering the second cleaning fluid i.e., water to the nozzle 130 and cleaning the component with the second cleaning fluid upon cleaning the component with the first cleaning fluid. For so doing, the controller 170 may control the first valve 132 and move the first valve 132 to the open position to deliver the water i.e., second cleaning fluid to the nozzle 130 and to spray the second cleaning fluid on the component, while positioning the second and third valves 134, 136 at the closed position. The controller 170 may keep the first valve 132 at the open position for a predetermined duration to spray a desired amount of the water on the component to effectively remove dirt and debris from the component.

Thereafter, the predefined sequence includes delivering the chemical to the nozzle 130 to spray the chemical on the component. For so doing, the controller 170 may control the third valve 136 and move the third valve 136 to the open position to deliver the chemical to the nozzle 130 and to spray the chemical on the component, while positioning the first and second valves 132, 134 at the closed position. The controller 170 may keep the third valve 136 at the open position for a predefined duration to spray the desired amount of chemical on the component.

In some embodiments, the predefined sequence also includes spraying the first cleaning fluid again on the component after cleaning the component with the second cleaning fluid and before spraying the chemical on the component. The spraying of the first cleaning fluid i.e., the compressed air before spraying the chemical and after spraying the water i.e., the second cleaning fluid, facilitates in drying of the component. For so doing, the controller 170 moves/actuates the second valve 134 to the open position and moves the first and third valves 132, 136 to the closed position. The controller 170 may keep the second valve 134 at the open position for a duration that enables desired drying of the component.

In some embodiments, the predefined sequence also includes spraying the first cleaning fluid i.e., compressed air, on the component after spraying the chemical to dry the chemical deposited on the component. Although one predefined sequence is explained in detail, it may be envisioned that multiple predefined sequences to spray the first cleaning fluid and/or the second cleaning fluid, and the chemical on the component may be stored inside the memory 174 of the controller 170, and the user may select any of the stored sequences to perform a desired chemical treatment. In some embodiments, the machine 100 may include a user interface (not shown) communicatively coupled to the controller 170, and the user may access the stored predefined sequences and select a desired sequence via the user interface to operate the valves 132, 134, 136 to perform the desired chemical treatment of the component.

In an embodiment, the machine 100 may include a plurality of switches (not shown) to enable the user to control opening and closing of the first valve 132, the second valve 134, and the third valve i.e., to control the flow of the water source, the pressurized air, and the chemical to the nozzle 130. In such a case, the user may operate the switches in a desired sequence to spray the chemical, the first cleaning fluid and/or the second cleaning fluid in a desired sequence.

In some embodiments, the machine 100 may include at least one sensor (not shown) to detect a successful flow of the at least one cleaning fluid and the chemical from the nozzle 130. In an embodiment, the at least one sensor may be mounted to the main conduit 166 and/or the nozzle 130 to detect the flow of the chemical and the at least one cleaning fluid through the main conduit 166 and/or the nozzle 130. Accordingly, the controller 170 is configured to determine a clogging of one or more conduits of the machine 100 when a desired flow is not detected by the at least one sensor. In some embodiments, additionally, or optionally, the sensors may be mounted to one or more of the first outlet conduit 160, the second outlet conduit 162, and the third outlet conduit 164 to detect the clogging of the respective one of the outlet conduits 160, 162, 164. The sensor may be optical flow detection sensor or any other suitable sensor that can measure flow of the fluid through a conduit or a pipe or a channel.

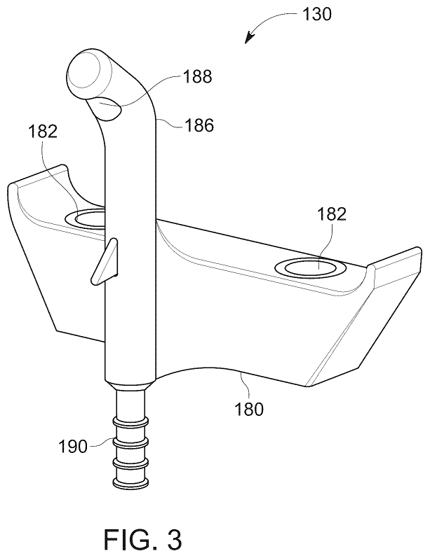

Further, to facilitate the chemical treatment of an upper surface of the underside frame 202 of the vehicle 200, the nozzle 130, referring to FIG. 3, includes a base 180 having at least one engagement structure 182 that enables a secure engagement of the nozzle 130 with the underside frame 202. In some embodiments, the at least one engagement structure 182 includes at least one magnet to magnetically couple the nozzle 130 with the underside frame 202. Moreover, the nozzle 130 includes an injector body 186 configured to partially extend inside a hole 204, shown in FIG. 4, of the underside frame 202 to enable the spray of the chemical and the cleaning fluid on the upper surface of the underside frame 202. As show, the injector body 186 includes an inlet portion 190 that remains below the underside frame 202, as shown in FIG. 5, when the base 180 is engaged with the underside frame 202. The injector body 186 also includes an outlet portion 188 that extends upwardly of the underside frame 202 through the hole 204. The outlet portion 188 includes a plurality of orifices to spray the chemical and the cleaning fluid. Although the machine 100 is contemplated to be used to chemically treat one or more components of the vehicle 200, it may be appreciated that the machine 100 may be utilized to treat components in general of any machine or structure.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A service machine for applying a chemical to one or more component of a vehicle, the service machine comprising:
a housing;
a valve assembly mounted to the housing and configured to receive at least one cleaning fluid from at least one cleaning fluid source and a chemical from a chemical reservoir; and
a nozzle fluidly connected to the valve assembly and configured to spray the at least one cleaning fluid and the chemical to the one or more components of the vehicle,
wherein the valve assembly selectively controls the flow of the at least one cleaning fluid and the chemical to the nozzle.

2. The service machine of claim 1 further including a controller configured to control the valve assembly to deliver the at least one cleaning fluid and the chemical to the nozzle in a predefined sequence and control the amount of the at least one cleaning fluid the chemical delivered to the nozzle.

3. The service machine of claim 2, wherein the valve assembly includes at least one valve to selectively connect the nozzle to the at least one cleaning fluid source and the chemical source to control the flow of the at least one cleaning fluid and the chemical to the nozzle.

4. The service machine of claim 3, wherein the at least one valve includes one of a solenoid actuated valve or pneumatically actuated valve.

5. The service machine of claim 2, wherein the at least one cleaning fluid includes a first cleaning fluid and a second cleaning fluid, wherein the predefined sequence includes delivering the first cleaning fluid to the nozzle, delivering the second cleaning fluid to the nozzle upon delivering the first cleaning fluid to the nozzle, and delivering the chemical to the nozzle upon delivering the first cleaning fluid to the nozzle.

6. The service machine of claim 1, wherein the nozzle includes at least one engagement structures to enable a removable engagement of the nozzle to the vehicle.

7. The service machine of claim 2, wherein the least one engagement structure includes at least one magnet adapted to be magnetically attached to the vehicle.

8. The service machine of claim 1, wherein the valve assembly includes
at least one inlet port adapted to be fluidly connected to the at least one cleaning fluid source to receive the cleaning fluid,
an inlet opening adapted to be fluidly connected to the chemical reservoir to receive the chemical, and
at least one outlet port adapted to be selectively connected with the at least one inlet port and the inlet opening to selectively allow the flow of the at least one cleaning fluid and the chemical reservoir, wherein the at least one valve selectively connect and disconnect the at least one outlet port to the at least one inlet port and the inlet opening.

9. The service machine of claim 8, wherein the at least one inlet port includes
a first inlet port adapted to be fluidly connected to a first cleaning fluid source of the at least one cleaning fluid source to receive a first cleaning fluid, and
a second inlet port adapted to be fluidly connected to a second cleaning fluid source of the at least one cleaning fluid source to receive a second cleaning fluid.

10. A service machine for applying a chemical to one or more component of a vehicle, the service machine comprising:
a housing;
a valve assembly mounted to the housing and configured to receive at least one cleaning fluid from at least one cleaning fluid source and a chemical from a chemical reservoir; and
a nozzle fluidly connected to the valve assembly and configured to spray the at least one cleaning fluid and the chemical to the one or more component of the vehicle, wherein the valve assembly selectively controls the flow of the at least one cleaning fluid and the chemical to the nozzle; and
a controller configured to control the valve assembly to deliver the at least one cleaning fluid and the chemical to the nozzle in a predefined sequence and control the amount of the at least one cleaning fluid and the chemical delivered to the nozzle.

11. The service machine of claim 10, wherein the valve assembly includes at least one valve to selectively connect the nozzle to the at least one cleaning fluid source and the chemical source to control the flow of the at least one cleaning fluid and the chemical to the nozzle.

12. The service machine of claim 11, wherein the at least one valve includes one of a solenoid actuated valve or pneumatically actuated valve.

13. The service machine of claim 10, wherein the at least one cleaning fluid includes a first cleaning fluid and a second cleaning fluid, wherein the predefined sequence includes delivering the first cleaning fluid to the nozzle, delivering the second cleaning fluid to the nozzle upon delivering the first cleaning fluid to the nozzle, and delivering the chemical to the nozzle upon delivering the first cleaning fluid to the nozzle.

14. The service machine of claim 10, wherein the nozzle includes at least one engagement structures to enable a removable engagement of the nozzle to the vehicle.

15. The service machine of claim 14, wherein the least one engagement structure includes at least one magnet adapted to be magnetically attached to the vehicle.

16. The service machine of claim 10, wherein the valve assembly includes
at least one inlet port adapted to be fluidly connected to the at least one cleaning fluid source to receive the cleaning fluid,
an inlet opening adapted to be fluidly connected to the chemical reservoir to receive the chemical, and
at least one outlet port adapted to be selectively connected with the at least one inlet port and the inlet opening to selectively allow the flow of the at least one cleaning fluid and the chemical reservoir, wherein the at least one valve selectively connect and disconnect the at least one outlet port to the at least one inlet port and the inlet opening.

17. The service machine of claim 16, wherein the at least one inlet port includes
a first inlet port adapted to be fluidly connected to a first cleaning fluid source of the at least one cleaning fluid source to receive a first cleaning fluid, and
a second inlet port adapted to be fluidly connected to a second cleaning fluid source of the at least one cleaning fluid source to receive a second cleaning fluid.

18. A service machine for applying a chemical to one or more component of a vehicle, the service machine comprising:
a housing;
a valve assembly mounted to the housing and configured to receive a compressed air from a pressurized air source, water from a water source, and a chemical from a chemical reservoir; and
a nozzle fluidly connected to the valve assembly and configured to spray the compressed air, the water and the chemical to the one or more component of the vehicle, wherein the valve assembly selectively controls the flow of the compressed air, the water and the chemical to the nozzle; and
a controller configured to control the valve assembly to spray the compressed air, the water and the chemical from the nozzle in a predefined sequence and control the amount of compressed air, the water, and the chemical delivered to the nozzle,
wherein the predefined sequence includes delivering the compressed air from the nozzle, delivering the water to the nozzle upon delivering the compressed air to the nozzle, delivering the compressed air to the nozzle after delivering the water to the nozzle, and delivering the chemical to the nozzle after delivering the compressed air to the nozzle.

19. The service machine of claim 18, wherein the valve assembly includes three valves to selectively connect the nozzle to the pressurized air source, the water source and the chemical source to control the flow of the compressed air, the water, and the chemical to the nozzle.

20. The service machine of claim 18, wherein each of the three valves includes one of a solenoid actuated valve or pneumatically actuated ON-OFF valve.
